(19) United States
(12) Patent Application Publication
(10) Pub. No.: US 2025/0032987 A1
(43) Pub. Date: Jan. 30, 2025

(54) A System for Processing Fluids

(71) Applicant: Fluid Equipment Development Company, LLC, Monroe, MI (US)

(72) Inventor: Eli Oklejas, Jr., New Port, MI (US)

(73) Assignee: Fluid Equipment Development Company, LLC, Monroe, MI (US)

(21) Appl. No.: 18/727,239

(22) PCT Filed: Dec. 5, 2022
(86) PCT No.: PCT/US2022/051771

§ 371 Date: Jul. 8, 2024

Related U.S. Application Data
(60) Provisional application No. 63/288,791, filed on Dec. 13, 2021.

(51) Int. Cl. B01D 61/02; C02F 1/44

(52) U.S. Cl. CPC B01D 61/026; C02F 1/441; B01D 2313/21; B01D 2313/243; B01D 2313/246; B01D 2313/60; B01D 2313/62; B01D 2317/022; B01D 2317/025; B01D 2317/06; C02F 2201/005; C02F 2209/003; C02F 2209/03; C02F 2209/10; C02F 2209/40; C02F 2301/08; C02F 2303/10

(57) ABSTRACT

A multistage reverse osmosis system for processing a fluid, the system comprising a first fluid processing membrane; a second fluid processing membrane, the second fluid processing membrane having an inlet for unprocessed fluid from the discharge of the first membrane; a third fluid processing membrane, the third fluid processing membrane having an inlet for receiving processed fluid from the first and second processing membranes, a high-pressure pump operatively connected to the inlet for the third fluid processing membrane, the high-pressure pump controlling the quantity of processed fluid from the first and second fluid processing membranes supplied to the inlet of the third processing membrane.

### BACKGROUND OF THE INVENTION

The reverse osmosis (RO) process uses a set of membrane elements that allow solvent (e.g., water) to pass through the membrane but blocks dissolved solids (e.g., salts). RO is used for desalination of brackish water and seawater where a feed stream is separated into a freshwater stream (called permeate) by the membrane and the balance is rejected as a concentrated brine stream (called concentrate or brine) which exits the membrane at a pressure slightly lower than the feed pressure entering the membrane array. This discussion will focus on desalination however it equally applies to all separation processes with any type of solvent that use membranes.

FIG. 1 shows an RO system consisting of a source of brackish or seawater connected to the high-pressure pump (HPP) 2 by pipe 1. The discharge of HPP 2 enters membrane 10 through pipe 4 with flow regulation provided by control valve 3. Permeate exits through pipe 7. Brine exits membrane 10 through pipe 5 to drain 6. Control valve 8 regulates brine flow.

The rate of permeate production, called the flux rate, in each membrane is determined by net driving pressure (NDP) which equals the fluid pressure minus the average osmotic pressure of the feed in that element. Osmotic pressure is determined by the concentration of dissolved solids. The feed becomes increasingly concentrated as it passes through succeeding membrane element experiences thus having a higher osmotic pressure and lower NDP than the preceding element.

Osmotic pressure is greatest in fluid boundary layer adjacent to the membrane surface. This is due to an enhanced concentration of dissolved solids resulting from permeation through the membrane surface. The concentration polarization parameter is the ratio of the boundary layer concentration to the bulk flow concentration. High polarization increases NDP and increases salt passage through the membrane. Polarization is minimized by avoiding high values of NDP and the resulting high flux rate.

Membranes allow some dissolved solids to pass through into the permeate stream. For those applications that require high permeate purity, another RO system, called the second pass is used that accepts permeate from the first pass. FIG. 2 shows the first pass 46 which is identical to the RO system in FIG. 1. Permeate from first pass 46 passes through pipe 7 to HPP 11 and then to membrane 12. Permeate exits membrane 12 through pipe 16. Brine exits through pipe 13 through control valve 14 and to pipe 15 that discharges into pipe 1 upstream of HPP 2. Note that brine from membrane 12 has a lower concentration of solids than the feed in pipe 1 thus provides dilution of concentration thereby reducing the pressure required by HPP 2.

Dissolved solids concentration is expressed as parts per millions (ppm) and is referred to as Total Dissolved Solids or TDS. The purpose of the RO process is to produce two streams of fluid-one with a very low TDS and the other, that must have very high TDS. Most RO processes focus on producing an output of very low TDS although some applications are optimized to achieve a very high level of TDS as in brine mining, pharmaceutical manufacture and protein concentration.

Energy recovery devices (ERDs) are often used to recover the hydraulic energy in the brine stream exiting the last stage. The ERD relevant to this disclosure is a turbocharger which uses the brine energy to boost the pressure of another stream, typically the feed entering a stage. Please refer to FIG. 3. The depicted system is like FIG. 2 with the addition of turbocharger 21. Feed from HPP 2 enters pump section 19 of turbocharger 21 that boosts pressure of the feed that then passes through pipe 9 to membrane 10. High-pressure brine exits membrane 10 through pipe 5 into turbine section 20 of turbocharger 21. Hydraulic energy is recovered and used to power pump section 19. The depressurized brine passes through pipe 7 to drain 6. Turbocharger 21 reduces the discharge pressure of HPP 2 thus saving energy and reducing the size and cost of the pump.

FIG. 4 shows additional prior art in which two membrane states are used in series. First stage 80 has the same functionality as in described the above prior art. A second stage 81 is added in which brine from first stage 80 exits through pipe 5 to pump section 27 of second turbocharger 26 that imparts a pressure boost. The brine then passes to second stage 81 in which additional permeate is extracted which then passes through pipe 31 to permeate manifold 32. Brine exits second stage 81 through pipe 25 to turbine section 28 of turbocharger 26. Partially depressurized brine exits through pipe 27 and enters first turbocharger 21 which fully depressurizes the brine and then passes through pipe 7 to drain 6. Note that brine flows through the turbine section of the turbochargers in series. The main advantage of this design is a higher recovery of permeate from a given feed flow. A disadvantage is that salt passage through second stage 81 is relatively high caused by a higher average concentration of dissolved solids in the feed stream.

### SUMMARY OF THE INVENTION

A system for processing a fluid to remove dissolved solids that uses pressure-based membranes. The fluid passes through multiple membranes to achieve the desired parameters for the fluid.

### DESCRIPTION OF THE DRAWINGS

FIG. 1 is a side elevational view.

FIG. 2 is a side elevational view.

FIG. 3 is a side elevational view.

FIG. 4 is a side elevational view.

FIG. 5 is a side elevational view.

FIG. 5A is a schematic view and diagram view of the function of the invention,

FIG. 6 is a side elevational view.

FIG. 7 is a partial side elevational view.

FIG. 8 is a partial side elevational view of a feature of the invention.

FIG. 8A is a partial side elevational view and diagram view of a feature of the invention.

FIG. 9 is a partial side elevational view of a feature of the invention.

FIG. 9A is a diagram view of a feature of the invention.

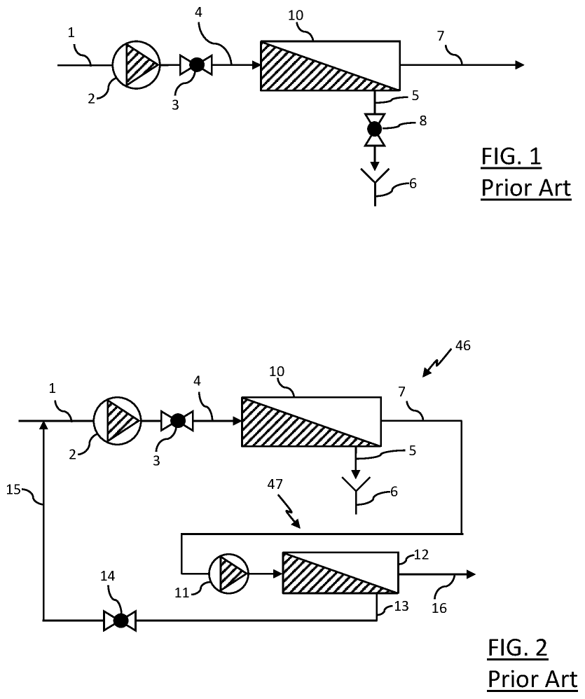

### DESCRIPTION OF THE INVENTION

The invention is directed to a system to process fluids to remove dissolved solids. Multiple pressure membranes are utilized to achieve the desired parameters for the processed fluid. The features of the invention will be more readily understood by referring to the following description in combination with the attached drawings.

Industry terminology defines “brine staging” as two or more sets of membranes with each membrane set receiving brine from the preceding membrane set. A “pass” is defined as a membrane set that receives permeate from another membrane set. For example, a “first pass” produces permeate that can be further processed in a “second pass”. Each pass may consist of one membrane set or two or more brine stages.

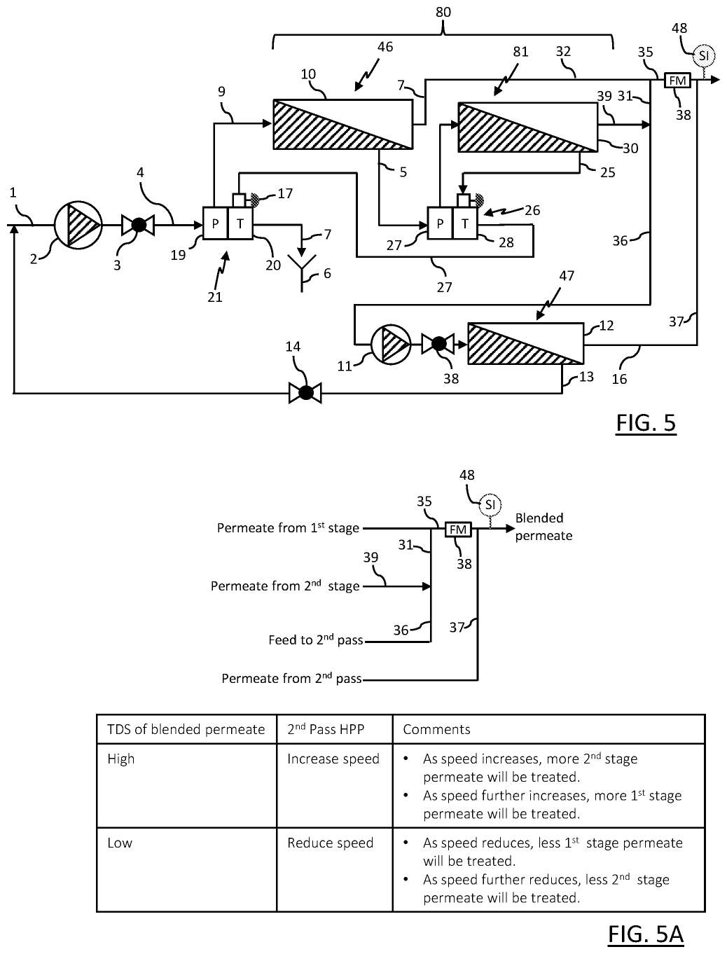

FIG. 5 depicts an embodiment of the invention which adds a second pass 47 membrane 12 to the previously discussed system of FIG. 4. The second pass is used to further process permeate from the first pass 46 which can include the first stage and second stage permeate. Permeate exits second stage 81 through pipe 39 to pipes 31 and 36. Pipe 31 is connected to permeate manifold 32. HPP 11 of second pass 47 draws permeate through pipe 36 with pressurize permeate passing through control valve 38 into membrane 12. Brine exits membrane 12 though pipe 13 and control valve 14 to pipe 1 upstream of HPP 2. Permeate exits second pass membrane 12 through pipe 37 to permeate manifold 32. A control valve 33 is positioned in pipe 31 between membrane 30 and permeate manifold 32. The control valve 33 functions to control the flow of permeate from the permeate manifold into pipe 36 and to the second pass 47 membrane 12.

An important aspect of the invention is that second pass 47 should treat the minimal amount of permeate to achieve the target value of salt or other dissolved solids concentration as measured by salinity indicator 48 mounted in permeate manifold 32 downstream of pipe 37. Since the permeate with the highest salt content is from second stage 81, that permeate should be treated first and an amount of permeate produced that is just sufficient to achieve the blended permeate TDS target as measured by salinity indicator 48. Thus, flow through pipe 36 may be less than or equal to flow from pipe 39 as needed to achieve the target TDS.

If the blended TDS level is not achieved by processing the entire flow from second stage 81, HPP 11 pump speed is increased to draw additional flow. In this case, a portion of first pass 46 permeate flow passes through pipe 31 and with all of the second stage 81 permeate flow enters pipe 36. Further increases in HPP 11 pump speed can draw the entire first pass 46 and second stage 81 permeate flow through second pass 47 membrane 12. Control valve 33 can be utilized to further regulate the flow of permeate from the first stage 46 into pipe 36 and to the second pass 47 membrane 12. Flow meter 34 monitors the flow in pipe segment 35. When the flow reads zero, the entire permeate flow is passing through second pass 47 and further increase in HPP 11 pump speed is possible but usually not warranted. The speed of HPP 11 is controlled to achieve the desired blend TDS level for the permeate passing through salinity indicator 48. The flow chart of FIG. 5A shows how the speed of HPP 11 is adjusted to achieve the desired result.

FIG. 5A shows the control philosophy for the second pass.

The above pipe arrangement ensures the optimal sequence in treating permeate.

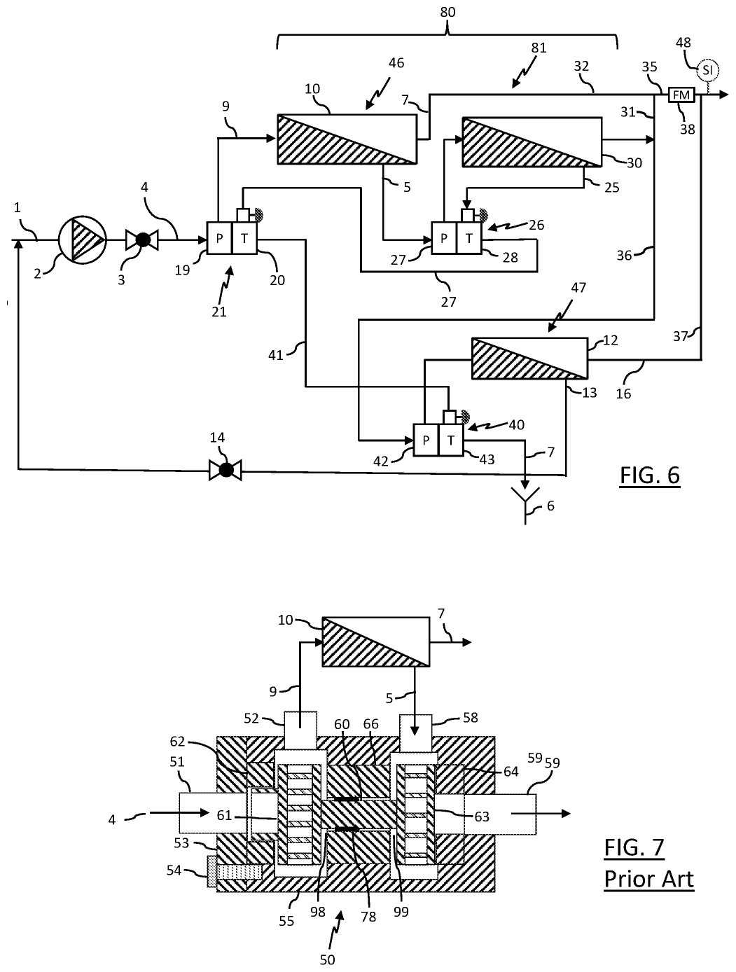

FIG. 6 depicts another embodiment of the system show in in FIG. 5 with the addition of a third turbocharger 40 added to the system. Turbocharger 40 provides pressurization for membrane 12 in second pass 47. Permeate passes through pipe 36 to pump section 42 of turbocharger 40 and then to membrane 12. A control valve 33 is positioned in pipe 31 between the membrane 30 and the permeate manifold 32. This control valve functions as previously described with regard to FIG. 5. Brine exits membrane 12 through pipe 13, through control valve 14 and to pipe 1 upstream of HPP 2.

Partially pressurized brine exits turbine section 20 of turbocharger 21 through pipe 41 to turbine section 43 of turbocharger 40. The partially pressurized brine drives the turbine section 43 of turbocharger 40 to increase the pressure of the permeate applied to membrane 12 from the pump section 42 of the turbocharger. Depressurized brine exits through pipe 7 to drain 6.

This embodiment uses brine energy from first stage 80 and second pass 47 for feed pressure boosting, and for second pass 47 feed pressurization achieving maximum utilization of brine hydraulic energy.

FIG. 7 shows a prior art turbocharger design for reverse osmosis applications. Pump impeller 61 and turbine impeller 63 are connected by shaft 60 that defines the rotor that is supported by journal bearing 66. Pump stationary wear ring 62 and thrust bearing 64 provide radial and axial position respectively. Casing 55 supports bearings 62, 66 and 64. End cap 53 is attached to casing 55 by bolt 54 to hold the components of the turbocharger in the desired position.

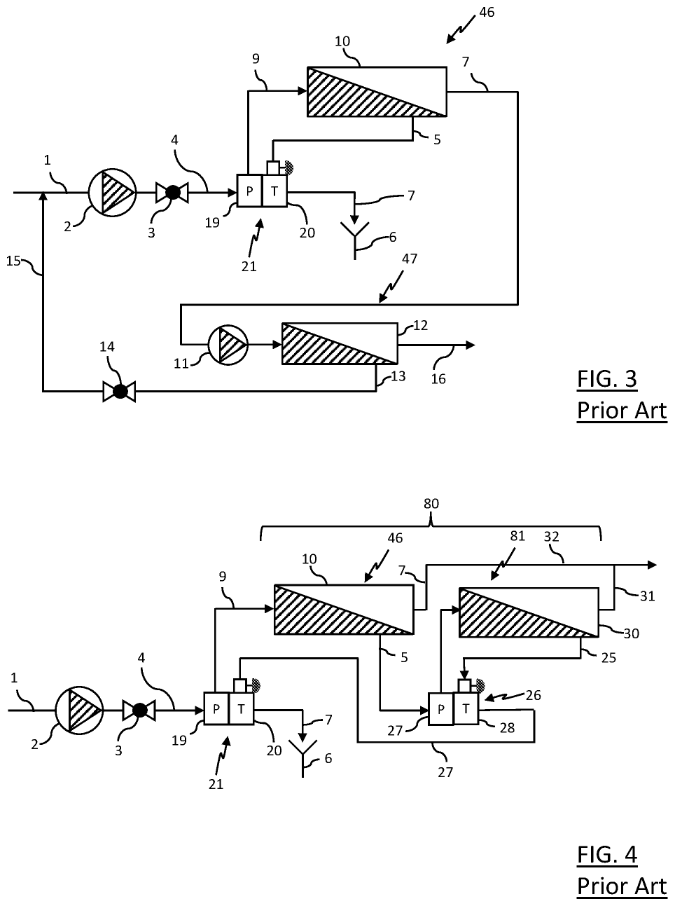

In a typical application such as depicted in FIG. 3, feed enters through port 51, is pressurized by pump impeller 61, exits through port 52 and passes to membrane 10 by pipe 9. Brine exits membrane 10 by pipe 5 into port 58. Brine is depressurized as it passes through turbine impeller 63 and exits through port 59. The brine exiting port 59 is usually directed to a drain. Note that brine pressure at port 58 is lower than feed pressure at port 52. Although there are several different pressure fields in the pump and turbine sides, the pressure at the feed end 98 of shaft 60 is higher than the brine pressure on turbine side 99 of the shaft. The result of this design is flow of feed through the journal bearing clearance toward the turbine section as depicted by arrows 78. This flow provides lubrication and heat removal. The flow rate is usually under 0.3% of the feed flow rate. Leakage of feed from the pump impeller to brine in the turbine impeller does not impair membrane performance. However, leakage of brine into the feed stream is not desirable.

However, the embodiment depicted in FIG. 6 shows brine entering turbine section 43 of turbocharger 40 from turbocharger 21 that is usually at a higher pressure than feed pressure exiting turbocharger 40. Thus, pressure at the turbine section 43 can be higher than the pressure at the pump section 42 resulting in a flow of brine into the feed side. Since the brine has a very high TDS, this flow will raise the TDS of the second pass feed flow resulting in increased permeate TDS from the second pass as well as higher energy consumption due to higher osmotic pressure.

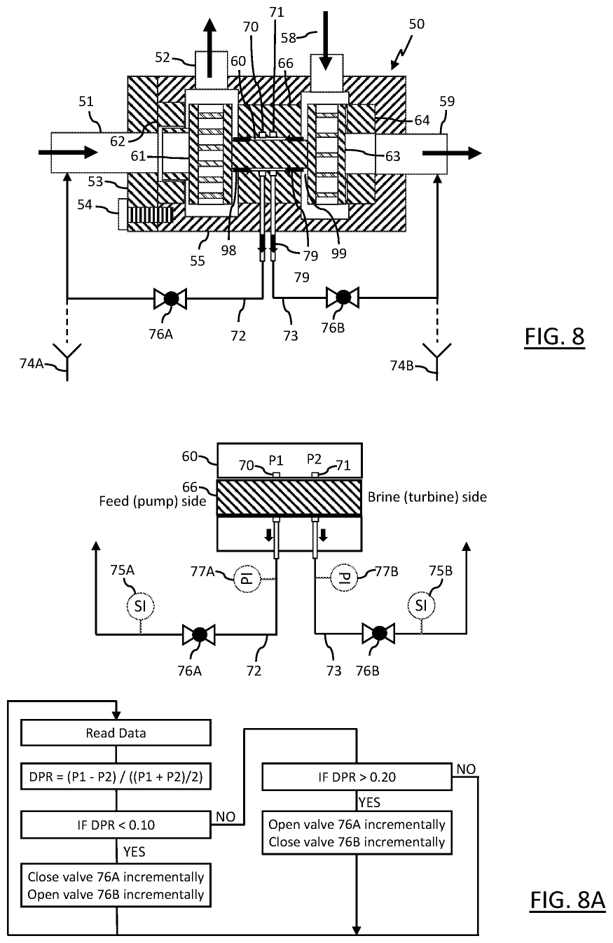

FIG. 8 presents an improvement of the turbocharger show in in FIG. 7 that prevents brine flow from entering the pump side of the turbocharger. Circumferential groove 71 in journal bearing 66, line 73 and drain port 74B are disposed toward the turbine end and circumferential groove 70, line 72 and drain port 74A are disposed towards the pump end. In practice it has been found that the distance between grooves 70 and 71 is preferred to be from about 10% to about 30% of the journal bearing length. During operation, control valves 76A and 76B are adjusted to prevent brine in the turbine section from entering the pump section.

Please refer to FIG. 8A that depicts in detail the bearing drain system details. Pressure indicators 77A and 77B, Salinity Indicators 75A and 75B and control valves 76A and 76B are mounted on bearing drain lines 72 and 73 respectively.

As shown in the flow chart in FIG. 8A, to prevent brine from reaching the feed side, pressure P1 in groove 70 must be greater than pressure P2 in grove 71 thus ensuring no brine can enter the feed side. If pressure indicator 77A shows a pressure lower than pressure indicator 778, then flow through the line 72 is reduced by adjusting control valve 76A (thus reducing the pressure drop from the feed side to groove 70). In addition, flow can be increased through the line 73 to drain port 74B by adjusting control valve 768 (thus increasing the pressure drop from the brine side to groove 71). Salinity meters 75A and 75B are optional and would be used to confirm that bearing drain TDS levels are expected—TDS in line 72 equals feed salinity and TDS in line 73 is slightly lower than brine TDS due to a minor amount of mixing with feed. The differential pressure ratio (DPR) between P1 and P2 is defined as P1−P2)/((P1+P2)/2). In practice it has been found that the DPR must have a positive value and should be held between 0.10 and 0.20.

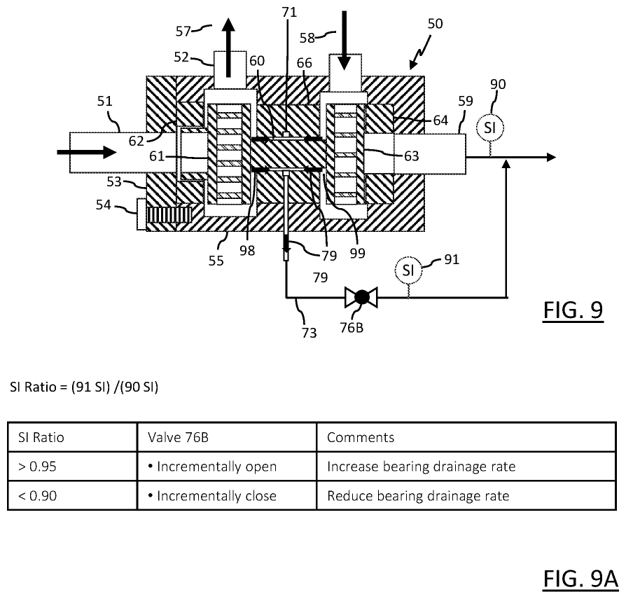

A single groove configuration for the turbocharger shown in FIG. 7 is depicted in FIG. 9. The single groove 71 may be located anywhere in the journal bearing length but in practice it has been found to be preferable to locate the single groove near the middle of the bearing length. In this embodiment, the required drainage flow rate through pipe 73 is determined by measurement of the drainage TDS using Salinity Indicator 91 and brine TDS using Salinity Indictor 90. If bearing drainage TDS is lower than the brine TDS, then it is certain that feed flow is entering groove 71 thus there can be no brine contamination of the feed side. The single groove 71 is connected by line 73 to the port 59 on the turbine side of the turbocharger. The port 59 is connected to a drain 6. The drain is at a lower pressure than the impeller or turbine side or the impeller side of the turbocharger. So, in most applications or operating conditions the fluid in the single groove 71, regardless of its source, will flow into the line 73.

FIG. 9A shows the control scheme. Salinity Indicator Ratio is calculated by dividing bearing drain TDS by brine TDS. The control philosophy is to regulate drainage flow rate by adjustment of control valve 768 until the SI Ratio is between 0.90 and 0.95. Keeping the SI Ratio slightly below one ensures that no brine will enter the feed side even if there are sudden changes in pressures between the feed and brine as may occur during startup or shutdown of the system.

The above description is given for the sake of explaining the features of the invention. Various substitutions and modifications can be made to the features of the invention without departing from the scope of the following claims.

1. A fluid purification system comprising:
a first fluid processing membrane, the first fluid processing membrane having an inlet for the fluid to be processed, an outlet for processed fluid on a first side of the membrane, and a discharge for unprocessed fluid on a second side of the first membrane;
a second fluid processing membrane, the second fluid processing membrane having an inlet for the unprocessed fluid from the discharge of the first membrane, an outlet for processed fluid on a first side of the second membrane and a discharge for unprocessed fluid on a second side of the second membrane;
a third fluid processing membrane, the third fluid processing membrane having an inlet for receiving processed fluid from the first and second processing membranes, an outlet for the processed fluid on a first side of the third membrane and a discharge for unprocessed fluid on a second side of the third membrane;
a high-pressure pump operatively connected to the inlet for the third fluid processing membrane, the high-pressure pump controlling the quantity of processed fluid from the first and second fluid processing membranes supplied to the inlet of the third processing membrane;
the outlet of the third fluid processing membrane being operatively connected to a header that is connected to the outlets of the first and second fluid processing membranes.

2. The system of claim 1 wherein the outlet of the first fluid processing membrane is connected to a first pipe, the outlet of the second fluid processing membrane is connected to a second pipe, the second pipe being connected to a conduit having a first end and a second end, the outlet for the third fluid processing membrane being connected to a third pipe, the first pipe, the first end of the conduit, and the third pipe being connected to the header, the first end of the conduit being connected to the header at a location between where the first pipe and third pipe are connected to the header, the second end of the conduit being connected to the inlet for the third fluid processing membrane.

3. The system of claim 2 wherein a sensor is positioned in the header to monitor the parameters of the combined processed fluid from the first, second and third fluid processing membranes, the sensor controlling the speed of the high-pressure pump and the quantity of processed fluid from the first and second fluid processing membranes supplied to the inlet of the third fluid processing membrane.

4. The system of claim 3 wherein a flow meter is positioned in the header to monitor the quantity of processed fluid from the first and second fluid processing membranes that are directed to the sensor.

5. The system of claim 3 wherein a power recovery turbine is operatively connected to the inlet for the third fluid processing membrane, the power recovery turbine having a pump side and a turbine side, the pump side of the power recovery turbine being connected to the outlet of the first and second fluid processing membranes, the turbine side of the power recovery turbine being operatively connected to the discharge for the second fluid processing membrane.

6. The system of claim 5 wherein the unprocessed fluid from the second fluid processing membrane powers the pump side of the power recovery turbine to supply the pressure for the fluid to be processed by the third fluid processing membrane.

7. A turbocharger having a housing with a pump side and a turbine side, the pump side having an inlet for fluid to be pressurized and an outlet for the pressurized fluid, the turbine side having an inlet opening to receive fluid under pressure and a discharge opening, a rotatable impeller positioned in the pump side and the turbine side, the rotatable impeller in the pump side and the turbine side being mounted on a rotatable shaft comprising:
a journal bearing located in the housing to support the rotatable shaft;
a first circumferential groove disposed in the journal bearing adjacent the pump side and a second circumferential groove disposed in the journal bearing adjacent the turbine side, the first and second circumferential grooves being adjacent the rotatable shaft;
a first drain port connected to the first circumferential groove and a second drain port connected to the second circumferential groove;
a first pressure indicator operatively connected to the first drain port and a second pressure indicator operatively connected to the second drain port;
a first line connected to the first drain port and to the inlet for the pump side, and a second line connected to the second drain port and the discharge opening for the turbine side;
a first valve positioned in the first line and a second valve positioned in the second line, the first and second valves being adjusted in response to the reading of the first and second pressure indicators to adjust the pressure in the first and second drain conduits so that the pressure in the first circumferential groove is greater than the pressure in the second circumferential groove whereby fluid from the turbine side is prevented from flowing through the journal bearing to the pump side.

8. The turbocharger of claim 7 wherein a first dissolved solids indicator is operatively connected to the first line and a second dissolved solids indicator is operatively connected to the second line.

9. The turbocharger of claim 7 wherein the distance between the first and second circumferential grooves is from about 10% to about 30% of the length of the journal bearing.

10. A turbocharger having a housing with a pump side and a turbine side, the pump side having an inlet for fluid to be pressurized and an outlet for the pressurized fluid, the turbine side having an inlet opening to receive fluid under pressure and a discharge opening, a rotatable impeller positioned in the pump side and the turbine side, the rotatable impeller in the pump side and the turbine side being mounted on a rotatable shaft comprising:
a journal bearing located in the housing to support the rotatable shaft;
a circumferential groove disposed in the journal bearing;
a drain port connected to the circumferential groove;
a line connected to the drain port;
a control valve positioned in the line to control fluid flow through the line;
a first dissolved solids indicator operatively connected to the line, the first dissolved solids indicator disposed on the side of the control valve that is spaced apart from the drain port;
a second dissolved solids indicator positioned on the discharge opening for the turbine side whereby the control valve can be adjusted to have the level of dissolved solids in the line be lower than the level of dissolved solids in the discharge opening whereby fluid is not flowing through the journal bearing from the turbine side to the pump side.
